(19) United States
(12) Patent Application Publication
(10) Pub. No.: US 2006/0100922 A1
(43) Pub. Date: May 11, 2006

(54) Guest screening device

(76) Inventors: Metin Odemis, Newport Beach, CA (US); Howard A. Harmond, Westminster, CA (US)

Correspondence Address: STETINA BRUNDA GARRED & BRUCKER, 75 ENTERPRISE, SUITE 250, ALISO VIEJO, CA, 92656, US

(21) Appl. No.: 10/973,218

(22) Filed: Oct. 25, 2004

(51) Int. Cl. G07G 1/14; G08B 13/00; G08B 3/00

(52) U.S. Cl. 705/14; 340/541; 340/691.6

(57) ABSTRACT

A guest screening device is provided that is operative to display an advertising message. The guest screening device may include a portal formed to allow a user to pass therethrough, a scanner, a sensor mounted proximate the portal, a controller, and at least one display device mounted proximate the portal. The controller may include an advertising database, a site-specific database, a security database, and may further access internet resources. In response to signals transmitted by the scanner or the sensor, the controller may generate specifically tailored advertising messages, user-messages, security messages and/or site-specific messages to optimize the value of advertising in a screening environment.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND OF THE INVENTION

1. Field of the Invention

The present invention relates generally to screening equipment, and more particularly, to a uniquely configured guest screening device specifically adapted to provide information messages to a user based upon advertising information, site-specific information and security information.

2. Description of the Related Art

With increasing frequency in today's society, individuals are screened in many situations. Such screening may be as simple as a ticket-taker at a sporting event or as complex as magnetic sensors at a supermarket, or the even more well-known airline security screening. For example, a concert or sporting event ticket holder may provide her ticket to an attendant, and the attendant may allow entrance to the ticket holder and direct her to the location of her seat. Security screening equipment at an airport requires a passenger to subject herself and her baggage to inspection. In all of these situations, screening may further require an individual to pass through a scanning device that will alert attendants of any unauthorized items such as knives, hand guns, or other unlawful or undesired items. Many businesses and schools today utilize screening equipment. Further examples are numerous as security screening equipment becomes more commonplace in large venues.

In the present state of the art in screening equipment, and given many of the possible safety concerns on the minds of many individuals, screening may be seen as a necessary evil. Many may be disgruntled by the amount of time they are required to stand at a security check. Others may be displeased with the lack of privacy associated with screening. Nevertheless, many may still recognize the need for such procedures in society today despite its drawbacks and nuisance.

An example may be illustrative. During security screening at an airport, passengers are required to undergo an intense individual security check. Often the lines are long, slow, and boring. Finally, when a passenger reaches the check point area, they are forced through as quickly as humanly possible. They may leave the security screening with untied shoelaces, a ticket in hand, and another headache: finding the correct terminal amidst myriad possibilities. Passengers may then deal with the inconvenience of scrambling to the arrival and departure monitors to see which gate they leave from or where a connection leaves from. Arriving passengers may also face similar challenges in finding luggage, rental cars, food courts, or other conveniences. Given such stresses, it is easy to see how a person may feel burdened and why they may seek to avoid the event altogether. Such procedures common today are repeated at many large venues where patrons struggle to locate their seats, restrooms, or other conveniences. However, the prior art screening devices appear to fail to address the aforementioned complaints common among most individuals.

Additionally, advertisers appear to always eagerly seek opportunities to target the right individual for their products at the right time. Effective advertising may be that advertising that is highly visible, attractive, and stimulating to the consumer. Given the quickly changing forms of advertising and related methodologies, there apparently always exists a need for improved methods of advertising. Again however, prior art screening devices do not apparently incorporate advertising features for such a captive audience located around screening checks.

Therefore, as noted above, there exists a need in the art for a security screening device that provides tailored and detailed information to a user regarding an event which makes the event more comfortable and convenient for the user. There is also a need in the art for screening technology that tends to create an attractive appeal without forfeiting safety and security.

Finally, there is a need in the art for effective advertising that incorporates daily consumer interactions and creates an environment wherein the consumer may be directed towards, entertained by, or stimulated by such advertising.

### BRIEF SUMMARY OF THE INVENTION

A guest screening device is provided that is operative to display an advertising message. The guest screening device provides informational messages that may be important and useful to a user. Additionally, such messages may include advertising from various sponsors. It is contemplated that interweaving advertising with useful, helpful messages tailored for individual users may enhance the effectiveness of advertising.

The guest screening device may comprise a portal sized and configured to allow the user to pass therethrough. The guest screening device may also include a controller including an advertising database for storing advertising information, the controller being operative to transmit a display signal including the advertising information. Additionally, the guest screening device may include at least one display device mounted proximate the portal and being operative to receive the display signal and display the advertising message, the advertising message being based upon the advertising information. The advertising message may include video display information.

The present invention may incorporate various features to enhance convenience for the user. In one embodiment of the present invention, the guest screening device may include a scanner positioned proximate the portal. The scanner may be operative to receive a slip or other record, and to transmit a scanner output signal representative of information derived from the slip. The controller may receive the scanner output signal and correlate the output signal to a site-specific database. The controller may be operative to selectively access the site-specific information in the site-specific database in response to the scanner output signal, and communicate a site-specific message to the display device. Alternatively, the controller may be operative to generate a user-specific message in response to the scanner output signal and communicate the user-specific message to the display device. The user-specific message, may be correlated to the advertising information and the site-specific information.

In another embodiment of the present invention, the guest screening device may include at least one sensor disposed adjacent the portal. The sensor may be operative to generate a sensor output signal in response to a sensed security condition as the user passes through the portal, and may transmit the sensor output signal to the controller, which may further include a security database. The controller may selectively access the information in the security database in response to the sensor output signal and communicate a security message to the display device. The sensor may be operative to detect unauthorized items made of materials such as metal or plastic, to determine the location of the unauthorized items on the user and to communicate the same to the controller via the sensor output signal.

In another embodiment of the present invention, the guest screening device may further include a video recording device. The video recording device may be operative to record an image of the user when the user is proximate the portal and may transmit the recorded image to the controller. The controller may be operative to store the recorded image in the security database.

Further, the controller may include a communications link operable to provide internet access to the controller. In this regard, the controller may selectively access the internet to update the advertising database, the user-specific database, the site-specific database, or the security database. Such updates may allow the guest screening device to provide up-to-the-minute information pertinent to the user and/or site.

In one embodiment of the present invention, the portal may include a truss framework with hollow members. It is contemplated that the portal construction be other possible shapes and arrangements suitable for use. It is also contemplated that the portal be made from aluminum or other materials that may work in the given application. For example, certain materials may be conductive and if in a given application, it would be advantageous to use another material, thus another material should be used for the portal construction. The sensor may be disposed within the hollow members of the truss framework. The sensor may be a magnetic sensor such as covert magnetic sensing hardware.

In accordance with another aspect of the present invention, a method of advertising is also provided. The method may include the steps of: providing a controller including an advertising database for storing advertising information; transmitting a display signal from the controller, the display signal including the advertising information; and displaying an advertising message on at least one display device, the advertising message being based upon the advertising information, the display device being operative to receive and display the display signal and being located proximate the portal.

In accordance with another aspect of the present invention, the controller may further include a site-specific database, and the method may also include the steps of scanning a slip; transmitting a scanner output signal to the controller, the scanner output signal being representative of slip information derived from the slip; selectively accessing site-specific information in the site-specific database in response to the scanner output signal; and communicating a site-specific message to the display device, the site-specific message being based upon the site-specific information.

The method may further include the step of generating a user-specific message in response the scanner output signal, the user-specific message being based upon the advertising information and the site-specific information, and communicating the user-specific message to the display device. The controller may also include a communications link operable to provide internet to the controller.

In another aspect of the present invention, the method may further include the steps of providing at least one sensor disposed adjacent the portal, the sensor being operative to generate a sensor output signal in response to a sensed security condition as the user passes through the portal and to transmit the sensor output signal to the controller, the controller including a security database; selectively accessing the security information and the security database in response to the sensor output signal; and communicating a security message to the display device, the security message being based upon the security information. The sensor may be operative to detect unauthorized items made of materials such as metal or plastic, to determine the location of the unauthorized items on the user, and to communicate the same to the controller via the sensor output signal.

Finally, the method may further include the steps of recording an image of the user when the user is proximate the portal; and transmitting the recorded image to the controller, the controller being operative to store the recorded image in the security database.

### BRIEF DESCRIPTION OF THE DRAWINGS

An illustrative and presently preferred embodiment of the invention is shown in the accompanying drawings in which:

FIG. 1 is a front perspective view of a guest screening device with a portal and display devices mounted proximate the portal, in accordance with an embodiment of the present invention;

FIG. 2 is a system diagram of the guest screening device illustrating the relationship of a controller for storing advertising information in an advertising database, and a display signal transmitted from the controller to the display device resulting in the display of an advertising message, in accordance with an embodiment of the present invention;

FIG. 3 is a system diagram of the guest screening device illustrating the relationship of the controller with a slip, a scanner, a scanner output signal, a site-specific database, the advertising database, the display signal, the display device, the advertising message, and a site-specific message, in accordance with an embodiment of the present invention;

FIG. 4 is another perspective view of the guest screening device with a user passing therethrough with an unauthorized item, the scanner is also shown in addition to the portal and the display devices, in accordance with an embodiment of the present invention;

FIG. 5 is another system diagram of the guest screening device illustrating the relationship of the controller with the slip, the scanner, the scanner output signal, the site-specific database, the advertising database, the display signal, the display device, the advertising message, the site-specific message, a sensor, a sensor output signal, a video recording device, a security database, a security message, and a user-specific message, in accordance with an embodiment of the present invention; and

FIG. 6 is a perspective view of a portion of the portal constructed as a truss framework with hollow members and sensors disposed within the hollow members of the truss framework.

### DETAILED DESCRIPTION OF THE INVENTION

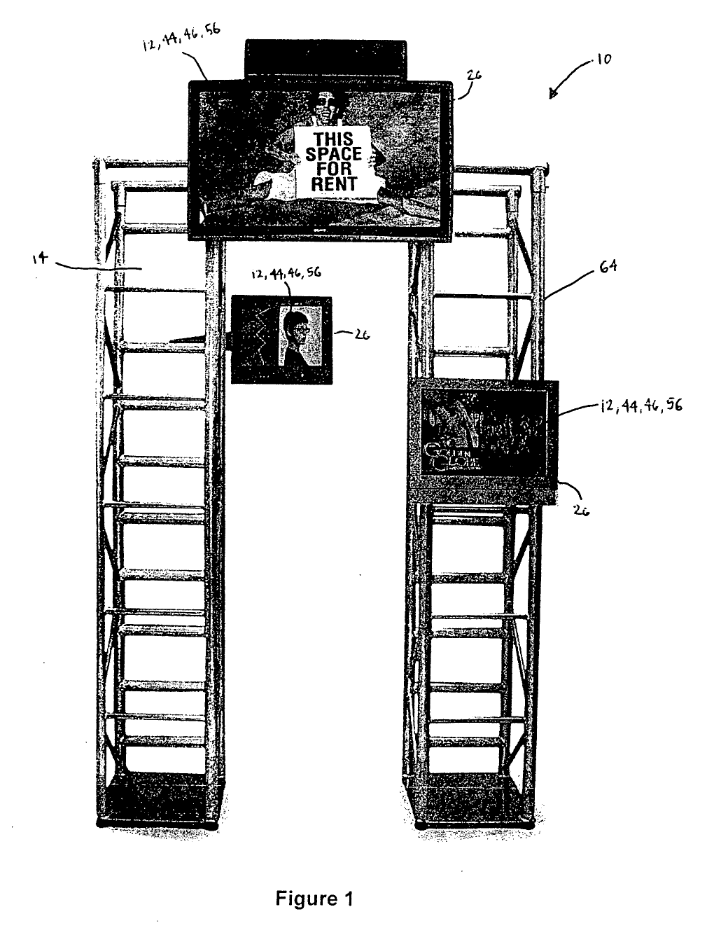

Referring now to the drawings wherein the showings are for purposes of illustrating the preferred embodiment of the present invention only and not for purposes of limiting the same, FIG. 1 is perspective front view of a guest screen device operative to display an advertising message 12. Although it is contemplated that the guest screening device 10 may be useful at sporting events, concerts, and airports, these are only a few of the possible venues wherein the guest screening device 10 may be beneficially used.

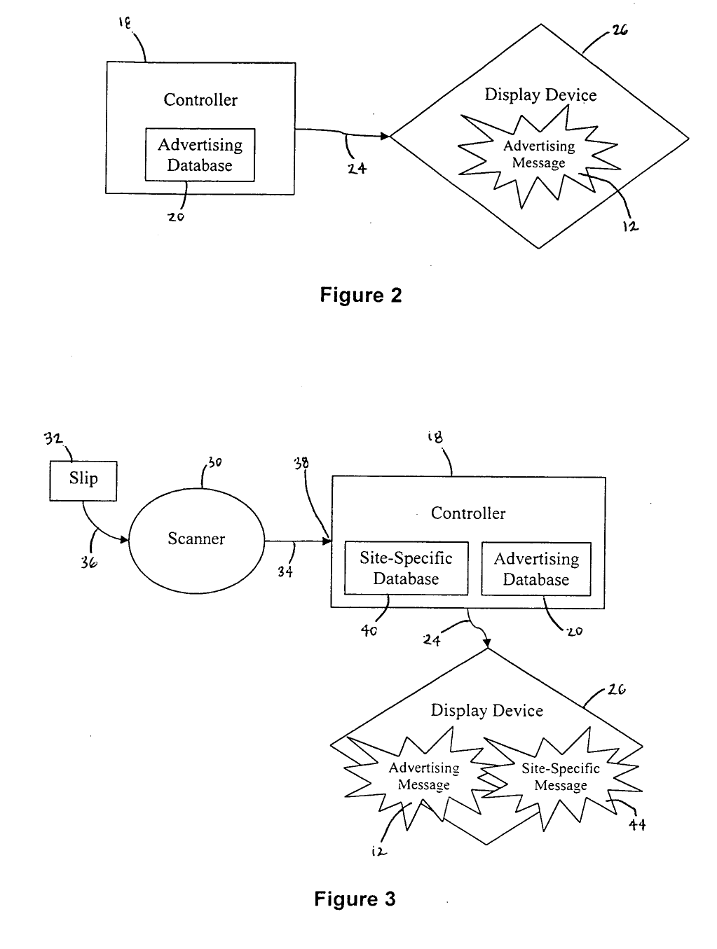

Referring now to FIGS. 1, 2 and 4, the guest screening device 10 may include a portal 14 sized and configured to allow a user 16 to pass therethrough; a controller 18 including an advertising database 20 for storing advertising information 22, the controller 18 being operative to transmit a display signal 24 including the advertising information 22; and at least one display device 26 mounted adjacent the portal 14 and being operative to receive the display signal 24 and display the advertising message 12, the advertising message 12 being based upon the advertising information 22. It is contemplated that the guest screening device 10 may include a plurality of portals, a plurality of controllers, and a plurality of display devices, enabling the guest screening device 10 to screen multiple persons at a time. Such an application may be useful in airports, sporting events, and other venues that support a large attendance. Additionally, it is contemplated that the portal 14 may allow any user 16 to pass through regardless of weight or height, and the portal 14 may also be formed to accommodate a wheelchair.

Referring now to FIG. 6, it is contemplated that the controller 18 be located adjacent the portal 14. The controller 18 may be mounted or installed within the portal 14, or may also be located external to the portal 14. In this regard, the controller 18 may operate remotely from the portal 14 and communicate remotely. Such a remote connection may be accomplished with an IR connection or radio waves. It is also contemplated that the controller 18 may be a computer.

Additionally, according to one aspect of the present invention the display device 26 may be mounted adjacent the portal 14; however the display device 26 may be mounted on the portal 14 itself or on wall adjacent the portal 14. Of utmost importance, the display device 26 should be mounted in an area adjacent the portal 14 where a user 16 may readily see the display device 26. It is contemplated that the display device 26 may be an LCD monitor or a projector. In this regard, the display device 26 may also include a video display. It is contemplated that the display device 26 may include an audio portion wherethrough the user 16 may be able to perceive the advertising message 12 through an audible medium.

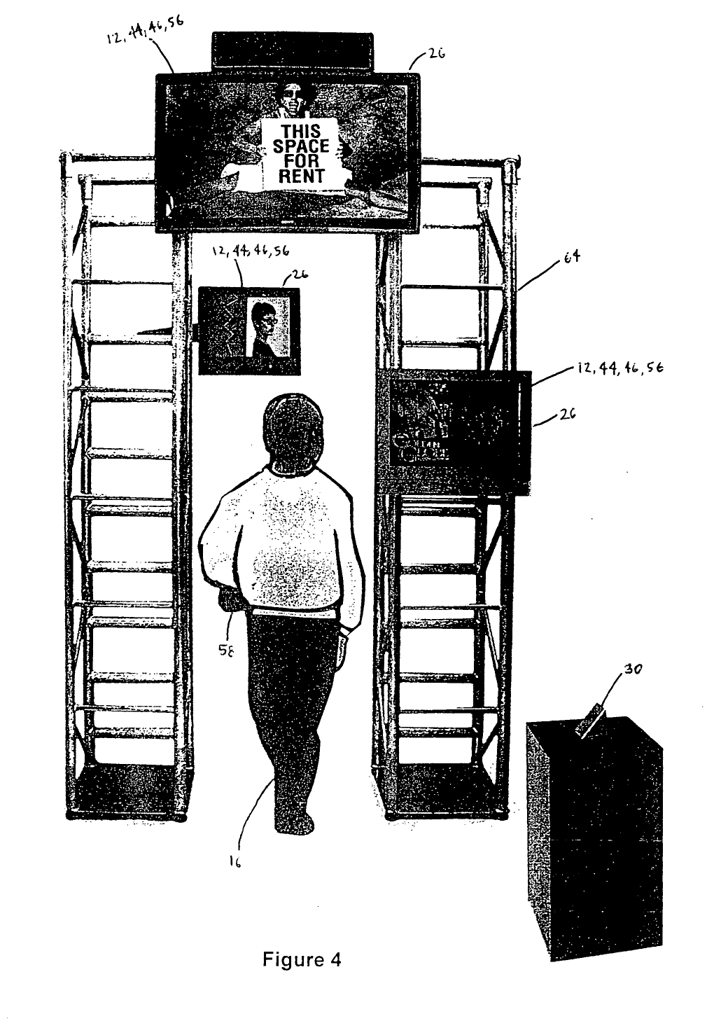

According to one embodiment of the present invention, as shown in FIGS. 1 and 4, the advertising message 12 may also include video display information 28. The advertising database 20 may be a DVD player accessible to the controller 18. As such, the advertising information 22 may be retrieved from the DVD. Nevertheless, it is also contemplated that the advertising database 20 may be any form of media player, such as a VCR, a cassette, or other media players such as those available through computer software applications.

According to another aspect of the present invention, as shown in FIG. 3, the guest screening device 10 may further include a scanner 30 positioned proximate the portal 14. The scanner 30 may be operative to receive a slip 32 and to transmit a scanner output signal 34 representative of slip information 36 derived from the slip 32. It is contemplated that the slip 32 may be any informational identifier such as a ticket or other printed medium, a magnetic card, or any unique physical characteristic of the user 16. In this regard, the scanner 30 may have the ability to read bar codes, sense magnetic fields, or identify unique physical characteristics of individuals. It is well known in the art that many scanners exist which have such broad capabilities. Nevertheless, the requirements of a scanner 30 may be determined by the system requirements and the type of slip 32 used for the guest screening device 10.

According to one aspect of the invention, referring to FIG. 3, the controller 18 may further include a controller 18 input port being operative to receive the scanner input signal. The controller 18 may also include a site-specific database 40, the controller 18 being operative to selectively access site-specific information 42 in the site-specific database 40 in response to the scanner output signal 34 and to communicate a site-specific message 44 to the display device 26, the site-specific message 44 being based upon the site-specific information 42. As mentioned previously, it is contemplated that the controller 18 be a computer. In this regard, the controller 18 may be capable of including site-specific information 42 and advertising information 22 that may be easily accessible upon receipt of the scanner output signal 34.

Furthermore, it is contemplated that the controller 18 generate a user-specific message 46 in response to the scanner output signal 34 and communicate the user-specific message 46 to the display device 26, the user-specific message 46 being based upon the advertising information 22 and the site-specific information 42. An example of such an embodiment may be the following. If the guest screening device 10 is used at a sporting venue, a user 16 may approach with her ticket in hand, pass the ticket through the scanner 30, and be allowed access through the portal 14. Immediately, the guest screening device 10 may display to the user 16 the user 16 message, which may indicate to the user 16 how the user 16 can most easily arrive at their seat, any emergency exit information, and other site-specific information 42 such as the location of restrooms, etc. In addition to the site-specific information 42 the user 16 may also be given information regarding the concession stands located around the sporting venue. It is contemplated that individual advertisers may elect to include their information in the advertising database 20 of the guest screening device 10. Thus, the advertisers may achieve greater visibility among individuals as their information is displayed upon the display devices of the guest screening device 10. In this regard, it is also contemplated that the user-specific message 46 be specifically tailored to a user 16 by correlating the slip information 36 to the advertising information 22 and the site information. Thus, an elderly user 16 may have a different user-specific message 46 than a young user 16, and a female user 16 may have a different user-specific message 46 than a male user 16. In this regard, it is contemplated that the controller 18 may take into account several attributes as provided by the slip information 36 in order to specifically tailor the user-specific message 46 to the individual user 16. For example, the controller 18 may tailor a user-specific message 46 for a user 16 traveling with children to indicate that the user 16 has time for a meal at a family restaurant, and direct the user to that restaurant. In this regard, the controller 18 may tailor the advertising information 22 and the site-information depending on the market demographic of the user—i.e., the controller 18 may correlate the advertising with the particular user 16 characteristics as discovered through the slip information 36.

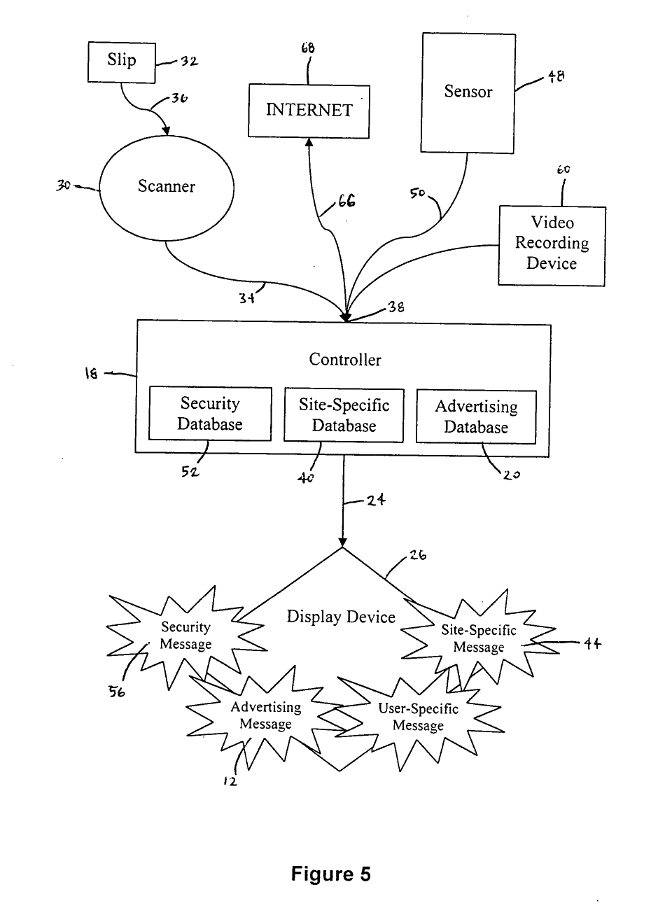

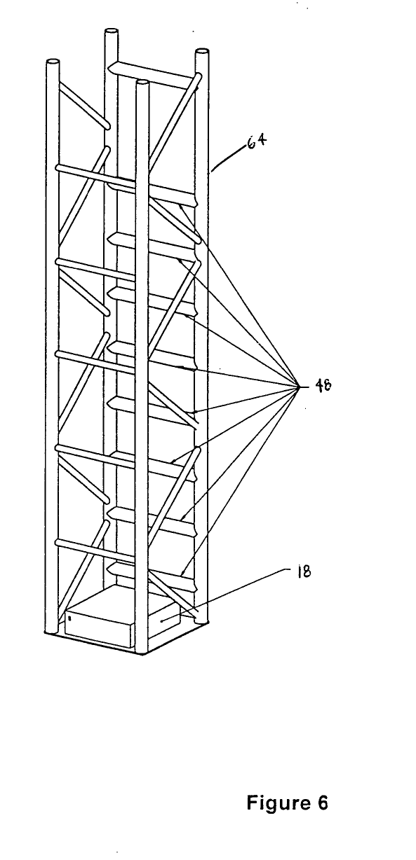

As shown in FIGS. 5 and 6, it is also contemplated that the guest screening device 10 may include at least one sensor 48 disposed adjacent the portal 14. The sensor 48 may be operative to generate a sensor output signal 50 in response to a sensed security condition as the user 16 passes through the portal 14 and to transmit the sensor output signal 50 to the controller 18. In one embodiment of the present invention, the controller 18 may further include a security database 52, the controller 18 being operative to selectively access security information 54 in the security database 52 in response to the sensor output signal 50 and to communicate a security message 56 to the display device 26, the security message 56 being based upon the security information 54. Thus the sensor 48 may be operative to detect an unauthorized item 58 made of materials such a metal or plastic, to determine the location of the unauthorized item 58 on the user 16 and to communicate the same to the controller 18 via the sensor output signal 50. It is thus contemplated that the security database 52 may also be included in the computer.

According to an embodiment of the present invention, the portal 14 may be a truss framework 64 with hollow members. The sensor 48 may be mounted to the portal 14. However, the sensor 48 may also be disposed within the hollow members of the truss framework 64. The sensor 48 may be a magnetic sensor 48, or other device such as a covert magnetic sensing hardware. It is contemplated that the sensor 48 may be discretely located within the guest screening device 10 so as to minimize the appearance of security screening. Such discrete construction may enhance the overall appearance of the guest screening device 10 and help users to feel not only protected, but also to feel unthreatened by the guest screening device 10. Thus the users may enjoy a comfortable entrance for a night at the opera, not become distressed each day at school, or relax as they pass through an already stressful airport.

As mentioned above, the controller 18 may include a security database 52. It is contemplated that the security database 52 include the security information 54 that may be accessed in response to the sensor output signal 50. The sensed security condition may include situations where the user 16 passes through the portal 14 carrying a weapon or other harmful device. However, it is also contemplated that the sensors 48 may detect any specified object. The range of objects detected by the sensors 48 is dictated by the application in which the guest screening device 10 is being used. For example, if the guest screening device 10 is being used at an airport, the sensors 48 may be magnetic induction sensors, passive magnetic based sensors, or simple applied magnetic field sensors. Thus, the sensor 48 may detect large or small objects of varying compositions. However, it is also contemplated that the sensors 48 may include x-ray or similar screening technology such that the user's person may be scanned for any unauthorized items 58.

In regard to the security message 56, as shown in FIG. 5, it is contemplated that depending upon the sensor output signal 50, the controller 18 may access certain security information 54 in the security database 52 to communicate a security message 56 to the display device 26. For example, if an individual is carrying an unauthorized item 58, the security message 56 may instruct the individual to proceed to the secure screening area, where the user 16 may be further screened.

According to another aspect of the present invention, as seen in FIG. 5, the screening device may further include a video recording device 60. The video recording device 60 may be operative to record an image 62 of the user 16 when the user 16 is proximate the portal 14 and may transmit the recorded image 62 to the controller 18, the controller 18 being operative to store the recorded image 62 in the security database 52. It is contemplated that the video recording device 60 be a camera which makes a continuous video recording as the user 16 passes through the portal 14. However, the video recording device 60 may also be a camera which takes a snapshot of the user 16 as the user 16 is proximate the portal 14. It is contemplated that the recorded image 62 of the user 16 be archived in the security database 52 together with the associated sensor output signal 50 and the sensed security condition. Thus, at a later date, the security database 52 may be accessed to retrieve information regarding a specific user 16, such as his recorded image 62, the sensed security condition, and the sensor output signal 50 and security message 56 displayed to the specific user 16. The sensed security condition may refer to the detection of a specific type of material or object on a user's person. This feature may be useful for law enforcement.

As shown in FIG. 5, the controller 18 may also include a communications link 66 providing internet 68 to the controller 18, the controller 18 being operative to access information from the internet 68 selected from the group consisting of advertising information 22, site-specific information 42 and security information 54. In this regard, it is contemplate that the controller 18 may retrieve additional advertising information 22, site-specific information 42, and security information 54. In this regard, the controller 18 may periodically update the advertising database 20, the site-specific database 40, and the security database 52. This feature may allow the guest screening device 10 to retrieve further information and further customize the user-specific message 46. A brief example may be that the controller 18 may be connected to the internet 68 which may display the listings for flight information or the weather information of a destination to which a user 16 is traveling. Thus when a user 16 passes through the guest screening device 10 at an airport, the guest screening device 10 may alert the user 16 as to any changes in their flight information, such as a delay, a change in the gate, or a cancellation of their flight, as well as the type of weather to expect once the user 16 arrives at the destination. The internet 68 feature of the controller 18 may also be useful at a sporting venue to alert incoming fans of specific details of the team, specific players, other late breaking news that may be of interest to the user 16. In another embodiment, the internet 68 feature may allow the controller 18 to alert a user 16 of new email messages in their inbox, personal emergencies such that they need contact their spouse or parent, or other myriad informational resources personalized to the user 16. Indeed, the controller 18 may provide numerous messages to the user 16, ranging from advertising to personal emergencies to weather alerts. The controller 18 may display messages limited only by the choice and creativity of the particular advertising and design.

Referring again to FIG. 3, the guest screening device 10 may comprise a portal 14 sized and configured to pass therethrough; a scanner 30 positioned proximate the portal 14, the scanner 30 being operative receive a slip 32 and to transmit a scanner output signal 34 representative of slip information 36 derived form the slip 32; a controller 18 including an advertising database 20 for storing advertising information 22, a site-specific database 40 and a controller 18 input port being operative to receive the scanner output signal 34, the controller 18 being operative to selectively access site-specific information 42 in the site-specific database 40 in response to the scanner output signal 34, the controller 18 being operative to transmit a display signal 24 including the advertising message 12 and a site-specific message 44 to display the device, the advertising message 12 being based upon the advertising information 22, the site-specific message 44 being based upon the site-specific information 42; and at least one display device 26 mounted proximate the portal 14 and being operative to receive the display signal 24 and display the advertising message 12 and the site-specific message 44.

In another embodiment of the present invention, a method of advertising is provided. The method may include the step of providing a controller 18 including an advertising database 20 for storing advertising information 22; transmitting a display signal 24 from the controller 18, the display signal 24 including advertising information 22; and displaying an advertising message 12 on at least one display device 26, the advertising message 12 being based upon the advertising information 22, the display device 26 being operative to receive and display the display signal 24 and being located proximate the portal 14. It is contemplated that the advertising message 12 include video display information 28.

In another embodiment of the present invention, the method may further include the steps of scanning a slip 32, transmitting a scanner output signal 34 to the controller 18, the scanner output being representative of slip information 36 derived from a slip 32; selectively accessing site-specific information 42 in the site-specific database 40 in response to the scanner output signal 34; and communicating a site-specific message 44 to the display device 26, the site-specific message 44 being based upon the site-specific information 42. It is contemplated that at least a portion of the site-specific database 40 may be located external to the controller 18; further including the steps of: generating a user-specific message 46 in response to the scanner output signal 34, the user-specific message 46 being based upon the advertising information 22 and the site-specific information 42; and communicating the user-specific message 46 to the display device 26.

According to another aspect of the present invention, it is further contemplated that the method may include the steps of: providing at least one sensor 48 disposed adjacent the portal 14, the sensor 48 being operative to generate a sensor output signal 50 in response to a sensed security condition as the user 16 passes through the portal 14 and to transmit the sensor output signal 50 to the controller 18, the controller 18 including a security database 52; selectively accessing security information 54 in the security database 52 in response to the sensor output signal 50; and communicating a security to the display device 26, the security message 56 being based upon the security information 54. It is further contemplated that the sensor 48 may be operative to detect an unauthorized item 58 made of materials such as metal or plastic, to determine the location of the unauthorized item 58 on the user 16 and to communicate the same to the controller 18 via the sensor output signal 50.

In yet another embodiment of the present invention, it is contemplated that the method may further include the steps of: recording an image 62 of the user 16 when the user 16 is proximate the portal 14, and transmitting the recorded image 62 to the controller 18, the controller 18 being operative to store the recorded image 62 in the security database 52.

Finally, it is contemplated that the method described herein may utilize a controller 18 which includes a communications link 66 providing internet 68 to the controller 18, the controller 18 being operative to access information from the internet 68 selected from the group consisting of advertising information 22, site-specific information 42 and security information 54.

What is claimed is:

1. A guest screening device being operative to display an advertising message, the guest screening device comprising:
a portal sized and configured to allow a user to pass therethrough;
a controller including an advertising database for storing advertising information, the controller being operative to transmit a display signal including the advertising information; and
at least one display device mounted proximate the portal and being operative to receive the display signal and display the advertising message, the advertising message being based upon the advertising information.

2. The guest screening device of claim 1 wherein the advertising message includes video display information.

3. The guest screening device of claim 1 further including a scanner positioned proximate the portal, the scanner being operative to receive a slip and to transmit a scanner output signal representative of slip information derived from the slip.

4. The guest screening device of claim 3 wherein the controller further includes a controller input port being operative to receive the scanner output signal.

5. The guest screening device of claim 4 wherein the controller includes a site-specific database, the controller being operative to selectively access site-specific information in the site-specific database in response to the scanner output signal and to communicate a site-specific message to the display device, the site-specific message being based upon the site-specific information.

6. The guest screening device of claim 5 wherein the controller generates a user-specific message in response to the scanner output signal and communicates the user-specific message to the display device, the user-specific message being based upon the advertising information and the site-specific information.

7. The guest screening device of claim 1 further including at least one sensor disposed adjacent the portal, the sensor being operative to generate a sensor output signal in response to a sensed security condition as the user passes through the portal and to transmit the sensor output signal to the controller.

8. The guest screening device of claim 7 wherein the controller further includes a security database, the controller being operative to selectively access security information in the security database in response to the sensor output signal and to communicate a security message to the display device, the security message being based upon the security information.

9. The guest screening device of claim 8 wherein the sensor is operative to detect an unauthorized item made of materials such as metal or plastic, to determine location of the unauthorized item on the user and to communicate the same to the controller via the sensor output signal.

10. The guest screening device of claim 8 further including a video recording device being operative to record an image of the user when the user is proximate the portal and to transmit the recorded image to the controller, the controller being operative to store the recorded image in the security database.

11. The guest screening device of claims 1 or 7 wherein the portal includes a truss framework with hollow members.

12. The guest screening device of claim 11 wherein the sensor is disposed within the hollow members of the truss framework.

13. The guest screening device of claim 12 wherein the sensor is a magnetic sensor.

14. The guest screening device of claims 1, 5 or 8 wherein the controller includes a communications link providing internet 68 to the controller, the controller being operative to access information from the internet 68 selected from the group consisting of advertising information, site-specific information, and security information.

15. A guest screening device being operative to display an advertising message, the guest screening device comprising:
a portal sized and configured to allow a user to pass therethrough;
a scanner positioned proximate the portal, the scanner being operative to receive a slip and to transmit a scanner output signal representative of slip information derived from the slip;
a controller including an advertising database for storing advertising information, a site-specific database and a controller input port being operative to receive the scanner output signal, the controller being operative to selectively access site-specific information in the site-specific database in response to the scanner output signal, the controller being operative to transmit a display signal including the advertising message and a site-specific message to the display device, the advertising message being based upon the advertising information, the site-specific message being based upon the site-specific information; and
at least one display device mounted proximate the portal and being operative to receive the display signal and display the advertising message and the site-specific message.

16. The guest screening device of claim 15 wherein the advertising message and the site-specific message include video display information.

17. The guest screening device of claim 15 wherein the controller generates a user-specific message in response to the scanner output signal and communicates the user-specific message to the display device, the user-specific message being based upon the advertising information and the site-specific information.

18. The guest screening device of claim 15 further including at least one sensor disposed adjacent the portal, the sensor being operative to generate a sensor output signal in response to a sensed security condition as the user passes through the portal and to transmit the sensor output signal to the controller.

19. The guest screening device of claim 18 wherein the controller further includes a security database, the controller being operative to selectively access security information in the security database in response to the sensor output signal and to communicate a security message to the display device, the security message being based upon the security information.

20. The guest screening device of claim 19 wherein the sensor is operative to detect an unauthorized item made of materials such as metal or plastic, to determine location of the unauthorized item on the user and to communicate the same to the controller via the sensor output signal.

21. The guest screening device of claim 19 further including a video recording device being operative to record an image of the user when the user is proximate the portal and to transmit the recorded image to the controller, the controller being operative to store the recorded image in the security database.

22. The guest screening device of claims 15 or 18 wherein the portal includes a truss framework with hollow members.

23. The guest screening device of claim 22 wherein the sensor is disposed within the hollow members of the truss framework.

24. The guest screening device of claim 23 wherein the sensor is a magnetic sensor.

25. The guest screening device of claims 15 or 19 wherein the controller includes a communications link providing internet 68 to the controller, the controller being operative to access information from the internet 68 selected from the group consisting of advertising information, site-specific information, and security information.

26. A method of advertising, the method comprising:
creating an advertising database for storing advertising information;
accessing the stored advertising information; and
displaying the advertising information on at least one display device, disposed upon a guest screening portal.

27. The method of claim 26 wherein the advertising message includes video display information.

28. The method of claim 26 wherein the method further including the steps of:
scanning a slip carried by user;
generating a scanner output signal representative of information derived from the slip;
selectively accessing site-specific information in a site-specific database in response to the scanner output signal; and
displaying the site-specific information with the advertising information.

29. The method of claim 28 further including the steps of:
generating advertising information in response to the site-specific information; and
communicating the advertising information and the site-specific information to the display device.

30. The method of claim 26 further including the steps of:
sensing a security condition as the user passes through the portal;
selectively accessing security information in a security database in response to the sensed security condition; and
communicating the security information to the display device.

31. The method of claim 30 wherein the sensing is operative to detect an unauthorized item carried by the user.

32. The method of claim 26 wherein the method further including the steps of:
scanning a slip carried by user;
generating a scanner output signal representative of information derived from the slip;
selectively accessing user-specific information in a site-specific database in response to the scanner output signal; and
displaying the user-specific information with the advertising information.

33. The method of claim 28 further including the steps of:
generating advertising information in response to the site-specific information; and
communicating the advertising information and the user-specific information to the display device.
